(19) United States
(12) Patent Application Publication
(10) Pub. No.: US 2026/0061667 A1
(43) Pub. Date: Mar. 5, 2026

(54) USE OF UV OR MICROWAVE RADIATION TO MANUFACTURE AN ORAL DISSOLVABLE FILM

(71) Applicant: Concept Matrix Solutions, Newbury Park, CA (US)

(72) Inventor: Robert Davidson, Woodland Hils, CA (US)

(21) Appl. No.: 19/314,322

(22) Filed: Aug. 29, 2025

Related U.S. Application Data
(60) Provisional application No. 63/689,129, filed on Aug. 30, 2024.

(51) Int. Cl. B29C 35/08; B29C 41/00; B29K 105/00

(52) U.S. Cl. CPC B29C 35/0805; B29C 41/003; B29C 2035/0855; B29K 2105/0035; B29K 2995/0059

(57) ABSTRACT

A method of manufacturing an oral dissolvable film that includes curing the slurry with ultraviolet radiation (UVR) and/or microwave radiation, alone or in combination with convection heat, to provide a cured film.

### CROSS-REFERENCE TO RELATED APPLICATIONS

This application claims the benefit of priority to U.S. Provisional Application No. 63/689,129, filed Aug. 30, 2025, the contents of which is hereby incorporated by reference.

### SUMMARY OF THE INVENTION

The present invention provides for a method of manufacturing an oral dissolvable film. The method includes: (a) forming or obtaining a cast slurry; and (b) curing the cast slurry with ultraviolet radiation (UVR) and/or microwave radiation, alone or in combination with convection heat, to provide a cured film. The method optionally further includes: (c) converting the cured film into desired dimensions to provide a cured film in a unit dosage form; and (d) packaging. In specific embodiments, the cast slurry can be formed by extruding a slurry and casting onto a substrate.

The present invention also provides for a method of manufacturing an oral dissolvable film, which includes: (a) forming or obtaining a cast slurry; and (b) curing the cast slurry with microwave radiation, alone or in combination with convection heat, to provide a cured film. The method optionally further includes: (c) converting the cured film into desired dimensions to provide a cured film in a unit dosage form; and (d) packaging. In specific embodiments, the cast slurry can be formed by extruding a slurry and casting onto a substrate.

The present invention also provides for an oral dissolvable film obtained from the method described herein.

### DETAILED DESCRIPTION OF THE INVENTION

The words “comprise,” “comprising,” “include,” “including,” and “includes” when used in this specification and claims are intended to specify the presence of stated substances, features, integers, components, or steps, but they do not preclude the presence or addition of one or more other substances, features, integers, components, steps, or combinations thereof.

The term “oral dissolvable film” (and alternative terms such as “oral soluble film,” “oral dissolvable strip,” “oral soluble strip,” “oral film,” “oral strip,” etc.) refers to a dissolvable film specifically configured for oral administration. The oral dissolvable film is self-supporting, or in other words, is able to maintain its integrity and structure in the absence of a separate support. Oral dissolvable films are composed of pharmaceutically acceptable ingredients that are edible or ingestible. The oral dissolvable film can be configured for multi- or unidirectional release. Similar in size and shape to a postage stamp, oral dissolvable films are designed for oral administration, with the user placing the film on the tongue (enteric), under the tongue (sublingual), on the oral mucosa (mucosal), against the inside of the cheek (buccal), or on the gums (gingival). Aside from the enteric route, these drug delivery options allow the active ingredient to bypass the first pass metabolism, thereby making the active ingredient more bioavailable. As the film dissolves, the active ingredient can enter the blood stream enterically, mucosally, buccally, gingivally, and/or sublingually. As such, the oral dissolvable film is typically prepared using hydrophilic polymers (e.g., film forming polymers) that dissolve on the tongue or buccal cavity, delivering the active ingredient to the systemic circulation via dissolution when contact with liquid is made. Oral film drug delivery accordingly uses a dissolving film to administer active ingredients via absorption in the mouth (buccally, sublingually, or gingivally) and/or via the small intestines (enterically). Especially for active ingredients which are metabolized extensively by the first-pass effect, oral films described herein provide an opportunity for a faster-acting and better absorption profile.

The oral dissolvable film described herein includes a polymeric matrix formed from a film forming agent (e.g., film-forming polymer), active pharmaceutical ingredient (API), and solvent. Optional additional excipients (alternatively referred to as “additives”) used to manufacture the oral film can include one or more of: mucoadhesive polymer, plasticizer, binder, filler, bulking agent, saliva stimulating agent, stabilizing and thickening agent, gelling agent, flavoring agent, taste masking agent, coloring agent, pigment, lubricant, release modifier, adjuvant, sweetening agent, solubilizer & emulsifier, fragrance, emulsifier, surfactant, pH adjusting agent, buffering agent, lipid, glidant, stabilizer, antioxidant, anti-tacking agent, humectant, solvent, permeation enhancer, and preservative. Suitable excipients or additives that can be used in the formulation of oral films are described in, e.g., Lachman, et al., “The Theory and Practice of Industrial Pharmacy,” 4th Edition (2013); Rowe et al., “Handbook of Pharmaceutical Excipients,” 8th Edition (2017); and Remington, “The Science and Practice of Pharmacy,” 22nd Edition (2015). From the regulatory perspectives, all excipients and additives used in the formulation of the oral films described herein should preferably be approved for use in oral pharmaceutical dosage forms.

It is appreciated that those of skill in the art understand that any substance employed in the slurry and/or oral dissolvable film can have multiple functions. However, unless the substance is otherwise indicated as having only a single function, reference to that substance as having a specified function is nonetheless appropriate and non-limiting, with the understanding that it may also have one or more additional functions. It is also appreciated that those of skill in the art understand that when feasible, the slurry and/or oral dissolvable film will preferably include substances that serve multiple desired purposes (e.g., possess multiple desired functions). In doing so, an oral dissolvable film can therefore be obtained that weighs less, dries quicker, disintegrates faster, and/or allows for a higher load of active ingredient.

The term “slurry” refers to a mixture of solids suspended and/or dissolved in liquid, and is suitable to be extruded, cast onto a substrate, and cured to form a dissolvable film. The solids and liquid will expectedly include those substances used to manufacture the oral dissolvable film. The solid substances employed in the manufacture of the oral dissolvable film can be dissolved and/or suspended in the liquid. The oral dissolvable film can be formed by curing the cast slurry, wherein the curing can be carried out at an elevated temperature for a period of time. In doing so, an appreciable amount of the solvent (e.g., water) will be removed.

The term “matrix,” “film matrix,” or “polymeric matrix” refers to the matrix of film forming polymer having the active ingredient embedded therein. In addition to the active ingredient, the polymeric matrix can further include additional substances embedded therein. These would include any one or more of those substances used to form the slurry. As the cast slurry is cured to provide a dissolvable film, a polymeric matrix is formed which contains the active ingredient (and optionally one or more additional substances) embedded therein. For example, when the slurry contains an active ingredient, film forming polymer, solvent, binder, and plasticizer, upon casting and curing to provide the dissolvable film, a polymeric matrix is formed which can contain each of the active ingredient, film forming polymer, solvent, binder, and plasticizer. Alternatively, the polymeric matrix can be formed containing each of the active ingredient, film forming polymer, binder, and plasticizer (i.e., no solvent).

The oral dissolvable film described herein can include a single film matrix. Alternatively, the oral dissolvable film can include multiple (e.g., 2, 3, 4, etc.) film matrices.

The term “active ingredient,” “active pharmaceutical ingredient,” or “API” is used to include any “drug,” “bioactive agent,” “preparation,” “medicament,” “therapeutic agent,” “physiological agent,” “nutraceutical,” or “pharmaceutical agent” and includes substances for use in the treatment of a disease or disorder. Dietary supplements, vitamins, functional foods (e.g., ginger, green tea, lutein, garlic, lycopene, capsaicin, and the like) are also included in this term. Additional active ingredients include cannabinoids (e.g., THC (tetrahydrocannabinol), THCA (tetrahydrocannabinolic acid), CBD (cannabidiol), CBDA (cannabidiolic acid), CBN (cannabinol), CBG (cannabigerol), CBC (cannabichromene), CBL (cannabicyclol), CBV (cannabivarin), THCV (tetrahydrocannabivarin), CBDV (cannabidivarin), CBCV (cannabichromevarin), CBGV (cannabigerovarin), CBGM (cannabigerol monomethyl ether), CBE (cannabielsoin), and CBT (cannabicitran)); terpenes (e.g., beta-caryophyllene, D-limonene, α-pinene, β-pinene, and linalool); and flavonoids (e.g., cannflavin A, cannflavin B, myricetin, (−)-epigallocathechin gallate, polyphenon 60 from green tea, (−)-gallocathechin, kaempferol, (+)-catechin hydrate, galangin, hesperidin, baicalein, icariin, orientin, liquiritigenin, acacetin, diosmetin, scutellarein, and luteolin). The term “active ingredient” also includes those substances falling with Schedule I-IV designations, such as, e.g., the psychedelics psilocybin, psilocin, baeocystin, mescaline, LSD, ketamine, salvinorin A, ibotenic acid, muscimol, DMT, MDMA, MDEA, and MDA. Standard references such as, e.g., The Physician's Desk Reference, 2018 Edition; The Merck Index, 15th Edition (2013); and United States Pharmacopeia (USP) (2018) provide a description of specific active ingredients.

The term “pharmaceutically acceptable” refers to those compounds, excipients, active ingredients, materials, compositions, and/or dosage forms that are, within the scope of sound medical judgment, suitable for use in contact with the tissues of human beings and animals without excessive toxicity, irritation, allergic response, or other problems or complications commensurate with a reasonable benefit/risk ratio. This would include, e.g., those substances present on the FDA's Inactive Ingredient Database (IID) (https://www.accessdata.fda.gov/scripts/cder/iig/index.Cfm) as well as those substances considered to be generally recognized as safe (GRAS).

The term “solvent” refers to a substance that dissolves a solute, resulting in a solution. With the oral dissolvable film described herein, the solute can include, e.g., the film forming polymer, the active ingredient and excipients such as, e.g., plasticizer, sweetener, flavoring agent, binder, preservative, coloring agent, and pH adjusting agent. Additionally, with the oral dissolvable film described herein, the slurry can be a solution. As such, the solvent is employed to form the slurry by dissolving the desired substances to be included in the slurry (and subsequently the oral dissolvable film). The solvent can be an aqueous solvent, thereby including water. Alternatively, the solvent can include an organic liquid, such as ethanol. The water present in the oral dissolvable film described herein can function as a solvent. Additionally, the water can further optionally function as a plasticizer, process aid, or combination thereof. The term “solvent” also embraces “co-solvent,” which is a substance, present along with the solvent, that aids, facilitates, or promotes the dissolving of the solute, to provide the solution (e.g., slurry). The co-solvent will typically include an organic liquid, such as glycerin, propylene glycol, polyethylene glycol, or a combination thereof.

The term “plasticizer” refers to a substance that, when added to polymer(s), they make the polymer more pliable and soft, enhancing the flexibility and plasticity of the films while reducing the brittleness. The plasticizer is believed to permeate the polymer structure, disrupting intermolecular hydrogen bonding, and permanently lowers intermolecular attractions. Plasticizers can be used to allow initial film forming, to reduce the brittleness, and improve the processability and flexibility of the resulting film, thereby avoiding cracking, e.g., during the curing process. Suitable plasticizers include, e.g., glycerin, water, polyethylene glycol, honey, propylene glycol, monoacetin, triacetin, triethyl citrate, sorbitol, 1,3-butanediol, D-glucono-1,5-lactone, diethylene glycol, castor oil, and combinations thereof.

The term “sweetener” or “sweetening agent” refers to a substance that provides a sweet taste. The sweetener can be natural or artificial. Suitable sweeteners include sugars (e.g., glucose, corn syrup, fructose, and sucrose) as well as sugar substitutes (e.g., honey, honey granules, aspartame, neotame, acesulfame potassium (Ace-K), saccharin, sodium saccharine, advantame, sucralose, monk fruit extract (mogrosides), stevia, rebaudioside A, sorbitol, xylitol, and lactitol).

The term “flavoring agent” refers to a substance used to impart a flavor, e.g., to improve the attractiveness and acceptance by the subject. The basic taste sensations are salty, sweet, bitter, sour, and umami. Flavors may be chosen from natural and synthetic flavorings. An illustrative list of such agents includes volatile oils, synthetic flavor oils, flavoring aromatics, oils, liquids, oleoresins or extracts derived from plants, leaves, flowers, fruits, stems and combinations thereof. The flavoring agent can include, e.g., one or more of honey, anise, cherry, mint, peppermint, spearmint, menthol, levomenthol, watermint, gingermint, lemongrass, cardamom, sage, cinnamon, ginger, allspice, clove, eugenol, orange, wintergreen, lemon, lime, tangerine, ginger, and nutmeg. The flavoring agent can be available as a solid (e.g., powder), as a liquid (e.g., oil), or a combination thereof.

The term “taste masking agent” refers to a substance used to mask the unpleasant taste of a substance present in the formulation, to improve the attractiveness and acceptance by the subject. For example, the taste masking agent can refer to a substance used to mask the bitter taste of the active ingredient. With the oral dissolvable films described herein, the taste masking agent can include, e.g., at least one of honey, anise, mint, peppermint, cinnamon, magna sweet, citrus, and fruit (e.g., cherry). In addition to imparting a flavor, the flavoring agent can optionally also mask the taste of any unpleasant or bitter tasting substances (e.g., the active ingredient) present in the oral dissolvable film. In such embodiments, the same substance can serve as both a flavoring agent and a taste masking agent.

The term “binder” refers to a substance, typically a polymer, used to hold the ingredients together. Binders ensure that the oral dissolvable films can be formed with the requisite mechanical strength. The binders also provide the requisite volume to low amount of active present in dissolvable films. The presence of the binder also facilitates the formation of the cured film. As such, the binder includes those substances, which when present in the cast slurry and upon curing, will effectively provide for a cured film. The binder may also be referred to as a “film forming agent,” or more specifically a “film forming polymer” when it is a polymer. The polymer can be a natural polymer or a synthetic polymer. Natural polymers include, e.g., pullulan, sodium alginate (Na alginate), pectin, gelatin, chitosan, and maltodextrin. Synthetic polymers include, e.g., hydroxpropyl cellulose (HPC), hydroxpropyl methylcellulose (HPMC), carboxymethyl cellulose (CMC), sodium carboxymethylcellulose (CMC-Na), microcrystalline cellulose (MCC), polyvinyl alcohol (PVA), polyethylene oxide (PEO), polyvinylpyrrolidone (PVP), and Kollicoat® (e.g., Kollicoat® Protect or Kollicoat® IR).

The term “mucoadhesive agent” refers to a substance that, upon contact with a mucosal surface (e.g., oral cavity), will adhere therein. The mucoadhesive agent, when placed in the oral cavity in contact with the mucosa therein, will adhere to the mucosa. The mucoadhesive agent permits a close and extended contact of the composition of the oral dissolvable film with the mucosal surface of the subject, by promoting adherence of the composition to the mucosa, and facilitating the release of the active ingredient from the composition. The mucoadhesive agent can be a polymeric compound, such as a cellulose derivative but it can be also a natural gum, alginate, pectin, or such similar polymer. The concentration of the mucoadhesive agent can be adjusted to vary the length of time that the film adheres to the mucosa or to vary the adhesive forces generated between the film and mucosa. Mucoadhesive agents include, e.g., carboxymethyl cellulose (CMC), carboxymethyl cellulose sodium (CMC-Na), polyvinyl alcohol, polyvinyl pyrrolidone (povidone), sodium alginate, methyl cellulose, hydroxyl propyl cellulose, hydroxypropylmethyl cellulose, polyethylene glycols, carbopol, polycarbophil, carboxyvinyl copolymers, propylene glycol alginate, alginic acid, methyl methacrylate copolymers, tragacanth gum, guar gum, karaya gum, ethylene vinyl acetate, dimenthylpolysiloxanes, polyoxyalkylene block copolymers, pectin, chitosan, carrageenan, xanthan gum, gellan gum, gum Arabic, locust bean gum, and hydroxyethylmethacrylate copolymers.

The term “preservative” refers to a substance that is added to prevent decomposition by microbial growth or by undesirable chemical changes. Some typical preservatives used in pharmaceutical formulations include: antioxidants like vitamin A, vitamin E, vitamin C, vitamin C palmitate, retinyl palmitate, and selenium; the amino acids cysteine and methionine; citric acid and sodium citrate; synthetic preservatives like the parabens: methyl paraben and propyl paraben. With the oral dissolvable films described herein, the preservative can include, e.g., any one or more of sodium benzoate, benzoic acid, sodium nitrite, sodium sorbate, potassium sorbate, and ascorbic acid.

The term “coloring agent,” “colorant,” or “pigment” refers to a substance used to impart a color, e.g., to improve the appearance and attractiveness by the subject. Color consistency can be significant, as it allows easy identification of a medication to the subject. Furthermore, colors often improve the aesthetic look and feel of medications. By increasing these organoleptic properties a subject is more likely to adhere to their schedule and therapeutic objectives will also have a better outcome for the subject.

The term “pH adjusting agent” refers to a substance that, when added to an aqueous solution (e.g., slurry), will change the pH. For example, the pH adjusting agent can be an acid, such that when added to an aqueous solution (e.g., slurry), it will decrease the pH. Alternatively, the pH adjusting agent can be a base, such that when added to an aqueous solution (e.g., slurry), it will increase the pH. The base can be an organic base (e.g., sodium bicarbonate) or inorganic base (e.g., sodium hydroxide), and the acid can be at least one of an inorganic acid (e.g., hydrochloric acid) and/or an organic acid (e.g., citric acid, malic acid, tartaric acid, etc.).

The term “buffering agent” refers to a weak acid or weak base used to maintain the pH (e.g., acidity or basicity) of a solution (e.g., slurry) near a chosen value after the addition of another acid or base. That is, the function of a buffering agent is to prevent a rapid change in pH when acids or bases are added to the solution (e.g., slurry). Buffering agents have variable properties-some are more soluble than others; some are acidic while others are basic. The acid can me an organic acid, mineral acid, or combination thereof. Likewise, the base can me an organic base, inorganic base, or combination thereof.

The terms “filler” and “bulking agent” refer to substances that add bulk to the pharmaceutical dosage form, making very small active ingredient components easy for consumer to take. Fillers are added to pharmaceutical dosage form to help with the manufacturing and stabilization of these products. Fillers bind and stabilize the dosage form. They do not alter or impact the effectiveness of the active pharmaceutical ingredient (API). Examples include: lactose, glucose, plant cellulose, microcrystalline cellulose (MCC), and calcium carbonate.

The term “saliva stimulating agent” or “salivary stimulant” refers to a substance capable of increasing the production of saliva, thereby increasing salivary flow rate. Suitable saliva stimulating agents include organic acids (e.g., ascorbic acid and malic acid), parasympathomimetic drugs (e.g., choline esters such as pilocarpine hydrochloride and cholinesterase inhibitors), physostigmine, and other substances (e.g., xylitol, xylitol/sorbitol, and nicotinamide).

The term “stabilizing and thickening agent” or “gelling agent” refers to substances employed to improve the viscosity and consistency of the slurry before casting. Active ingredient content uniformity is often a requirement for all dosage forms, particularly those containing low dose highly potent active ingredients. To uniquely meet this requirement, oral dissolvable film formulations can contain uniform dispersions of active ingredient throughout the whole manufacturing process. Examples of stabilizing and thickening agents include, e.g., alginic acid, sodium alginate, potassium alginate, ammonium alginate, calcium alginate, agar, carrageenan, locust bean gum, pectin, and gelatin.

The term “solubilizer & emulsifier” or “emulsifier” refers to a substance capable of forming or promoting an emulsion. In particular reference to the oral dissolvable films described herein, the emulsifier promotes the separation of phases (e.g., aqueous and lipids), while allowing them to be mixed. Suitable emulsifiers include, e.g., Polysorbate 80, glycerin, propylene glycol, and polyethylene glycol.

The term “emulsion” refers to a mixture of two or more liquids that are normally immiscible (nonmixable or unblendable). Emulsions are part of a more general class of two-phase systems of matter called colloids. Although the terms colloid and emulsion are sometimes used interchangeably, emulsion should be used when both the dispersed and the continuous phase are liquids. In an emulsion, one liquid (the dispersed phase) is dispersed in the other (the continuous phase). Examples of emulsions include vinaigrettes, milk, mayonnaise, and some cutting fluids for metal working. The photo-sensitive side of photographic film is an example of a colloid.

The term “lipid” refers to a group of naturally occurring molecules that include fats, waxes, sterols, fat-soluble vitamins (such as vitamins A, D, E, and K), monoglycerides, diglycerides, triglycerides, phospholipids, and others. “Lipid” may also refer to ethoxylated fatty alcohols such as oleth-10 and laureth-10 and mixtures of ethoxylated mono and diglycerides such as PEG-16 macadamia glycerides and PEG-10 sunflower glycerides. The compounds are hydrophobic or amphiphilic small molecules. The amphiphilic nature of some lipids allows them to form structures such as vesicles, liposomes, or membranes in an aqueous environment. Biological lipids originate entirely or in part from two distinct types of biochemical subunits or “building-blocks”: ketoacyl and isoprene groups. Using this approach, lipids may be divided into eight categories: fatty acids, glycerolipids, glycerophospholipids, sphingolipids, saccharolipids, and polyketides (derived from condensation of ketoacyl subunits); and sterol lipids and prenol lipids (derived from condensation of isoprene subunits). Although the term lipid is sometimes used as a synonym for fats, fats are a subgroup of lipids called triglycerides. Lipids also encompass molecules such as fatty acids and their derivatives (including tri-, di-, monoglycerides, and phospholipids), as well as other sterol-containing metabolites such as cholesterol. Suitable lipids include, e.g., almond oil, argan oil, avocado oil, canola oil, cashew oil, castor oil, cocoa butter, coconut oil, colza oil, corn oil, cottonseed oil, grape seed oil, hazelnut oil, hemp oil, hydroxylated lecithin, lecithin, linseed oil, macadamia oil, mango butter, marula oil, mongongo nut oil, olive oil, palm kernel oil, palm oil, peanut oil, pecan oil, perilla oil, pine nut oil, pistachio oil, poppy seed oil, pumpkin seed oil, rice bran oil, safflower oil, sesame oil, Shea butter, soybean oil, sunflower oil, walnut oil, and watermelon seed oil.

The term “humectant” refers to a substance used to keep the slurry and/or oral dissolvable film moist. A humectant attracts and retains the moisture in the air nearby via absorption, drawing the water vapor into or beneath the oral dissolvable film's surface. This is the opposite use of a hygroscopic material where it is used as a desiccant used to draw moisture away. Humectants can be used in oral dissolvable films to increase the solubility of active ingredients, increasing the active ingredients' ability to penetrate a mucosal surface, or its activity time. Examples include, e.g., propylene glycol, hexylene glycol, butylene glycol, aloe vera gel, alpha hydroxy acids (e.g., lactic acid), glyceryl triacetate, and sugar alcohols or polyols (e.g., glycerol, sorbitol, xylitol, and maltitol).

The term “lubricant” or “glidant” refers to a substance added to the formulation (e.g., slurry) to improve processing characteristics. For example, the lubricant can enhance flow of the slurry by reducing interparticulate friction. Suitable lubricants include, e.g., magnesium stearate, calcium stearate, stearic acid, hydrogenated vegetable oil (e.g., Sterotex, Lubritab, and Cutina), mineral oil, polyethylene glycol 4000-6000 (PEG), sodium lauryl sulfate (SLS), sodium hyaluronate, sucrose esters, glyceryl behenate (stelliesters), dimethyl phthalate, diethyl phthalate, dibutyl phthalate, tributyl citrate, triethyl citrate, acetyl citrate, triacetin, dioctyl adipate, diethyl adipate, di(2-methylethyl) adipate, dihexyl adipate, partial fatty acid esters of sugars, polyethylene glycol fatty acid esters, polyethylene glycol fatty alcohol ethers, polyethylene glycol sorbitan fatty acid esters, 2-ethoxy ethanol, ethyl alcohol, propyl alcohol, butyl alcohol, pentyl alcohol, hexyl alcohol, heptyl alcohol, octyl alcohol, dibutyl tartrate, castor oil, or any combination thereof.

The term “stabilizer” refers to a substance employed to that is used to prevent degradation of any one of more substances present in the slurry and/or oral dissolvable film. This would include the active ingredient as well as any of the inactive ingredients (e.g., excipients or additives).

The term “antioxidant” refers to a substance that inhibits or prevents oxidation of any one of more substances present in the slurry and/or oral dissolvable film. This would include the active ingredient as well as any of the inactive ingredients (e.g., excipients or additives). Examples of antioxidants include, e.g., ascorbic acid (vitamin C), vitamin A, α-tocopherol (vitamin E), beta-carotene, glutathione, ubiquinol (coenzyme Q), and selenium.

The term “anti-tacking agent” refers to a substance employed to prevent the formation of lumps (caking) of powdered or granulated materials. Use of the anti-tacking agent can result in the ease of flowability of the solid powders used to form the slurry. Crystalline solids often cake by formation of liquid bridge and subsequent fusion of microcrystals. Amorphous materials can cake by glass transitions and changes in viscosity. Polymorphic phase transitions can also induce caking. Examples include, e.g., calcium silicate, calcium carbonate, and magnesium carbonate.

The term “fragrance” (alternatively known as an odorant or aroma compounds) refers to a substance employed to impart a desired smell or odor.

The term “surfactant” refers to a substance that lower the surface tension (or interfacial tension) between two liquids, between a gas and a liquid, or between a liquid and a solid. When present in the slurry and/or oral dissolvable film described herein, the surfactant may act as a detergent, wetting agent, emulsifier, foaming agent, and/or dispersant.

The term “adjuvant” refers to a substance (e.g., pharmacological or immunological agent) that modifies (e.g., increases) the effect or efficacy of the active ingredient.

The term “release modifier” refers to a substance employed to modify the release of active ingredient from the oral dissolvable film and/or to modify the absorption of active ingredient when administered to the subject. The modified drug release can be contrasted to an immediate release (IR), and includes, e.g., an extended release (XR) or delayed release (DR).

The term “permeation enhancer” refers to a substance employed to increase the delivery the active ingredient, when administered in vivo (e.g., orally), across the desired body surface (e.g., oral mucosa, such as buccal, sublingual, mucosa, or gingival; or an intestinal surface), resulting in an increased absorption of the active ingredient.

The term “powder matrix” refers to a coating of solid substance on the surface of the oral dissolvable film. The solid substance is intended to directly contact the external surface(s) of the polymeric matrix (of the oral dissolvable film), but is not intended to be present within the polymeric matrix. As such, the powder coating does not impregnate or penetrate the polymeric matrix to any appreciable and significant degree. The powder matrix is typically administered to the oral dissolvable film to form the applied coating after the oral dissolvable film has been manufactured (e.g., after the cast slurry has been cured). Alternatively, the powder matrix can be administered during the curing (e.g., while the cast slurry is being cured). Either way, the powder matrix can be applied in any desired manner, including sifting, screening, atomization, static, mechanical agitation, etc. For example, the powder matrix can be atomized through a Nordson or similar static spray gun using compressed air. One such gun creates a fine mist spray of powder particles. The gun statically electrically charges the powder particles so they adhere to a surface of the film that is receiving the powder particles. Another process for applying the powder particles is to admix the particles with a liquid carrier to form a particle-liquid solution. The particle-liquid solution is sprayed on the film. The liquid carrier evaporates, leaving the powder particles on the film. The liquid carrier preferably does not cause the powder particles to dissolve in the liquid carrier. Examples of substances that can be present in the powder matrix include, e.g., a binder, saliva stimulating agent, flavoring agent, taste masking agent, coloring agent, lubricant, sweetening agent, surfactant, pH adjusting agent, buffering agent, glidant, anti-tacking agent, permeation enhancer, or any combination thereof.

The term “unit dosage form” refers to an oral dissolvable film sized to the appropriate dimension, such that the individual film contains a desired amount of active ingredient. Prior to sizing to the appropriate dimension (thereby providing the unit dosage form), the dissolvable film can exist in either the unwound form (e.g., sheet) or in the wound form (e.g., bulk roll).

The term “thickness” refers to the distance between opposite sides of the oral dissolvable film. The thickness is the smallest of the three dimensions (length, width, and thickness). The thickness of the film can be measured by a micrometer screw gauge or calibrated digital Vernier Calipers. The thickness can be evaluated at five different locations (four corners and one at center) and in specific embodiments may be significant to ascertain uniformity in the thickness of the film, as this may be directly related to accuracy of dose distribution in the film.

The term “mass” refers to a measurement of how much matter is in an object. Mass is a combination of the total number of atoms, the density of the atoms, and the type of atoms in an object. Mass is usually measured in grams (which is abbreviated as g) or milligrams (which is abbreviated as mg).

The term “drug load” or “load of active ingredient” refers to the amount of active pharmaceutical ingredient present in the oral dissolvable film. For example, in specific embodiments the oral dissolvable film can have a high drug load, such that the active pharmaceutical ingredient is present therein in a relatively high amount (e.g., above 30 wt. % of the oral dissolvable film).

The term “density” refers to the mass per unit volume of an object (e.g., oral dissolvable film). Density is calculated by dividing the mass of an object by the volume of the object. The volume of an object can be stated as cubic centimeters or milliliters as both are equivalent.

The term “loss on drying (LOD)” refers to the loss of weight expressed as percentage w/w resulting from water and/or volatile matter that can be driven off under specified conditions from an object (e.g., oral dissolvable film). In this technique, a sample of material (e.g., oral dissolvable film) is weighed, heated in an oven for an appropriate period, cooled in the dry atmosphere of a desiccator, and then reweighed. The difference in weight is the loss on drying (LOD). For example, the oral dissolvable film can have a loss on drying (LOD) of 10±2 wt. %.

The term “tack” refers to the tenacity with which the oral dissolvable film adheres to an accessory (a piece of paper) that has been pressed into contact with the film.

The term “tensile strength” refers to the maximum stress applied to a point at which the oral dissolvable film specimen breaks. It is calculated by the applied load at rupture divided by the cross-sectional area of oral dissolvable film, as given in the equation below:

$$Tensile strength = Load at failure \times 100 / Film thickness \times Film width$$

The term “percent elongation” refers to the relative increase in amount in length upon application of stress. When stress is applied on a film sample, it gets stretched. This is referred to as strain. Strain is basically the deformation of film before it gets broken due to stress. It can be measured by using hounsfield universal testing machine. Generally, elongation of the film increases as the plasticizer content increases. It is calculated by the formula:

$$\% Elongation = Increase in length of film \times 100 / Initial length of film$$

The term “tear resistance” refers to the resistance which a film offers when some load or force is applied on the film specimen. Specifically, it is the maximum force required to tear the specimen. The load mainly applied can be of a very low rate (e.g., 51 mm/min). The unit of tear resistance is Newton or pounds-force.

The term “Young's modulus” or “elastic modulus” refers to the measure of stiffness of a dissolvable film. It is represented as the ratio of applied stress over strain in the region of elastic deformation as follows:

$$Young ' s modulus = Slope \times 100 / Film thickness \times Cross head speed$$

Hard and brittle strips demonstrate a high tensile strength and Young's modulus with small elongation.

The term “folding endurance” refers to number of times the film can be folded without breaking or without any visible crack. Folding endurance gives the brittleness of a film. The method followed to determine endurance value is that the film specimen are repeatedly folded at the same place until it breaks or a visible crack is observed. The number of times the film is folded without breaking or without any visible crack is the calculated folding endurance value.

The term “drug content uniformity,” “uniformity of dosage unit” or “CU” refers to the degree of uniformity in the amount of drug substance among dosage units, and unless otherwise specified, is set forth in USP-NF General Chapter <905> Uniformity of Dosage Units.

The term “dissolution” refers to a substance (e.g., oral dissolvable film or matrix of an oral dissolvable film) dissolving or being dissolved to release the API. When placed in the oral cavity, the substance will dissolve in saliva.

The term “disintegration” refers to a substance (e.g., matrix of an oral dissolvable film) breaking up or falling apart. The substance will lose cohesion or strength and can fragment into pieces. When placed in the oral cavity, the substance will break apart in the saliva.

The term “effective amount” is used herein to generally include an amount of active ingredient present in the oral dissolvable film, effective for treating or preventing a disease, disorder, or condition in a subject, as described herein.

The term “treating” with regard to a subject, refers to improving at least one symptom of the subject's disease, disorder, or condition. Treating includes curing, improving, or at least partially ameliorating the disease, disorder, or condition, or any of the symptoms thereof.

The term “subject” is used herein to generally include humans. The subject can particularly include human infants (e.g., up to 3 years old), human children (e.g., 4-11 years old), human adolescents (e.g., 12-17 years old), and human male adults (e.g., at least 18 years old). Unless otherwise specified, the human can be a male or female.

The term “oral administration” refers to a route of administration where a substance is taken through the mouth. Many medications are taken orally because they are intended to have a systemic effect, reaching different parts of the body via the bloodstream.

The term “mucous membrane” (and related “mucosa” and “mucosal surface”) refers to a membrane that lines various cavities in the body or covers those surfaces. It consists of one or more layers of epithelial cells overlying a layer of loose connective tissue. It is mostly of endodermal origin and is continuous with the skin at various body openings such as the eyes, ears, inside the nose, inside the mouth, lip, vagina, the urethral opening and the anus. Some mucous membranes secrete mucus, a thick protective fluid. The function of the membrane is to stop pathogens and dirt from entering the body and to prevent bodily tissues from becoming dehydrated. Mucosal surfaces specifically include, e.g., oral mucosa, tongue, vaginal mucosa, nasal mucosa, and the anal canal.

The term “transmucosal,” as used herein, refers to any route of administration via a mucosal membrane or mucosal surface. Examples include, but are not limited to, buccal, sublingual, nasal, vaginal, and rectal.

The term “buccal administration” refers to a topical route of administration by which a drug held or applied in the buccal area (in the cheek) diffuses through the oral mucosa (tissues which line the mouth) and enters directly into the bloodstream. Buccal administration may provide better bioavailability of some drugs and a more rapid onset of action compared to oral administration because the medication does not pass through the digestive system and thereby avoids first pass metabolism.

The term “buccal space” (also termed the “buccinator space”) refers to a fascial space of the head and neck (sometimes also termed fascial tissue spaces or tissue spaces). It is a potential space in the cheek, and is paired on each side. The buccal space is superficial to the buccinator muscle and deep to the platysma muscle and the skin. The buccal space is part of the subcutaneous space, which is continuous from head to toe.

The term “oral mucosa” refers to the mucous membrane lining the inside of the mouth and consists of stratified squamous epithelium termed oral epithelium and an underlying connective tissue termed lamina propria. Oral mucosa can be divided into three main categories based on function and histology: (1) Masticatory mucosa, keratinized stratified squamous epithelium, found on the dorsum of the tongue, hard palate and attached gingiva; (2) Lining mucosa, nonkeratinized stratified squamous epithelium, found almost everywhere else in the oral cavity, including the: (a) Buccal mucosa refers to the inside lining of the cheeks and floor of the mouth and is part of the lining mucosa; (b) Labial mucosa refers to the inside lining of the lips and is part of the lining mucosa; and (c) Alveolar mucosa refers to the lining between the buccal and labial mucosae. It is a brighter red, smooth and shiny with many blood vessels, and is not connected to underlying tissue by rete pegs; and (3) Specialized mucosa, specifically in the regions of the taste buds on lingual papillae on the dorsal surface of the tongue that contains nerve endings for general sensory reception and taste perception.

The term “sublingual administration,” from the Latin for “under the tongue,” refers to the pharmacological route of administration by which substances diffuse into the blood through tissues under the tongue. When a drug comes in contact with the mucous membrane beneath the tongue, it is absorbed. Because the connective tissue beneath the epithelium contains a profusion of capillaries, the substance then diffuses into them and enters the venous circulation. In contrast, substances absorbed in the intestines are subject to first-pass metabolism in the liver before entering the general circulation. Sublingual administration has certain advantages over oral administration. Being more direct, it is often faster, and it ensures that the substance will risk degradation only by salivary enzymes before entering the bloodstream, whereas orally administered drugs must survive passage through the hostile environment of the gastrointestinal tract, which risks degrading them, by either stomach acid or bile, or by enzymes such as monoamine oxidase (MAO). Furthermore, after absorption from the gastrointestinal tract, such drugs must pass to the liver, where they may be extensively altered; this is known as the first pass effect of drug metabolism. Due to the digestive activity of the stomach and intestines, the oral route is unsuitable for certain substances.

The term “gingival administration” refers to the pharmacological route of administration by which substances diffuse into the blood through tissues in the gums. The gums or gingiva (plural: gingivae), consist of the mucosal tissue that lies over the mandible and maxilla inside the mouth.

The term “enteral administration” refers to a drug administration via the human gastrointestinal tract. Enteral administration involves the esophagus, stomach, and small and large intestines (i.e., the gastrointestinal tract). Methods of administration include oral and rectal. Enteral administration may be divided into three different categories, depending on the entrance point into the GI tract: oral (by mouth), gastric (through the stomach), and rectal (from the rectum). (Gastric introduction involves the use of a tube through the nasal passage (NG tube) or a tube in the belly leading directly to the stomach (PEG tube). Rectal administration usually involves rectal suppositories.) Enteral medications come in various forms, including, e.g., tablets to swallow, chew or dissolve in water; capsules and chewable capsules (with a coating that dissolves in the stomach or bowel to release the medication there), oral soluble films, time-release or sustained-release tablets and capsules (which release the medication gradually), osmotic delivery systems, powders or granules, and liquid medications or syrups.

The term “ultraviolet radiation” or “UVR” refers to electromagnetic radiation with a wavelength from 10 nm to 400 nm, with a corresponding frequency of approximately 30 PHz to 750 THz. The electromagnetic spectrum of ultraviolet radiation (UVR), defined most broadly as 10-400 nanometers, can be subdivided into a number of ranges recommended by the ISO standard ISO-21348: ultraviolet A (UVA), having a wavelength of 400-315 nm and photon energy of 3.10-3.94 eV; ultraviolet B (UVB), having a wavelength of 315-280 nm and photon energy of 3.94-4.43 eV; ultraviolet C (UVC), having a wavelength of 280-100 nm and photon energy of 4.43-12.4 eV; near ultraviolet (NUV), having a wavelength of 400-300 nm and photon energy of 3.10-4.13 eV; middle ultraviolet (MUV), having a wavelength of 300-200 nm and photon energy of 4.13-6.20 eV; far ultraviolet (FUV), having a wavelength of 200-122 nm and photon energy of 6.20-10.16 eV; hydrogen lyman-alpha (H Lyman-α), having a wavelength of 122-121 nm and photon energy of 10.16-10.25 eV; vacuum ultraviolet (VUV), having a wavelength of 200-10 nm and photon energy of 6.20-124 eV; and extreme ultraviolet (EUV), having a wavelength of 121-10 nm and photon energy of 10.25-124 eV.

The term “microwave radiation” or “MR” refers to a form of electromagnetic radiation with wavelengths shorter than other radio waves (as originally discovered) but longer than infrared waves. Its wavelength ranges from about one meter to one millimeter, corresponding to frequencies between 300 MHz and 300 GHz, broadly construed. A more common definition in radio-frequency engineering is the range between 1 and 100 GHz (wavelengths between 30 cm and 3 mm), or between 1 and 3000 GHz (30 cm and 0.1 mm). The prefix micro- in microwave is not meant to suggest a wavelength in the micrometer range; rather, it indicates that microwaves are small (having shorter wavelengths), compared to the radio waves used in prior radio technology.

The boundaries between far infrared, terahertz radiation, microwaves, and ultra-high-frequency (UHF) are fairly arbitrary and are used variously between different fields of study. In all cases, microwaves include the entire super high frequency (SHF) band (3 to 30 GHz, or 10 to 1 cm) at minimum. A broader definition includes UHF and extremely high frequency (EHF) (millimeter wave; 30 to 300 GHz) bands as well.

High-power microwave sources use specialized vacuum tubes to generate microwaves. These devices operate on different principles from low-frequency vacuum tubes, using the ballistic motion of electrons in a vacuum under the influence of controlling electric or magnetic fields, and include the magnetron (used in microwave ovens), klystron, traveling-wave tube (TWT), and gyrotron. These devices work in the density modulated mode, rather than the current modulated mode. This means that they work on the basis of clumps of electrons flying ballistically through them, rather than using a continuous stream of electrons.

Low-power microwave sources use solid-state devices such as the field-effect transistor (at least at lower frequencies), tunnel diodes, Gunn diodes, and IMPATT diodes. Low-power sources are available as benchtop instruments, rackmount instruments, embeddable modules and in card-level formats. A maser is a solid-state device which amplifies microwaves using similar principles to the laser, which amplifies higher frequency light waves.

A microwave oven passes microwave radiation at a frequency near 2.45 GHz (12 cm), causing dielectric heating primarily by absorption of the energy in water. Microwave ovens became common kitchen appliances in Western countries in the late 1970s, following the development of less expensive cavity magnetrons. Water in the liquid state possesses many molecular interactions that broaden the absorption peak. In the vapor phase, isolated water molecules absorb at around 22 GHz, almost ten times the frequency of the microwave oven.

Microwave heating can be used in an industrial processes for drying and curing a slurry to provide an oral thin film.

Microwave heating can be used in an industrial processes

| | | |
|---|---|---|
| 1 | Application | Microwave heating can be used to dry and cure a slurry to form an |
| | | oral thin film |
| 2 | Advantages | Rapid and energy-efficient heating compared to conventional |
| | | methods |
| | | Uniform heat distribution throughout the material |
| | | Provides shorter processing times and increased throughput |
| 3 | Drying | Effective for drying a slurry |
| | applications | Used as a preliminary drying step in mixed systems, followed by |
| | | hot air drying |
| | | Efficiently evaporates water from materials due to the “water |
| | | pump” effect |
| 4 | Curing | Used for curing a slurry |
| | applications | |
| 5 | System design | Industrial microwave systems customized for specific |
| | | applications |
| | | Designed for continuous, discontinuous, or stationary heating |
| | | Single-mode or multi-mode cavities depending on the |
| | | application |
| 6 | Materials suitable | Thin sheet materials |
| | for microwave | Effective for materials with high moisture content |
| | heating | |
| 7 | Integration with | Used for pre-heating or post-drying in combination with |
| | other processes | conventional heating methods |
| | | Integrated into existing production lines to improve efficiency |
| 8 | Energy sources | Typically use magnetrons as microwave energy sources |
| | | Operate at frequencies of 915 MHz or 2450 MHz |

Industrial microwave heating systems offer advantages in terms of speed, energy efficiency, and process control for drying and curing applications across various industries. They are particularly useful for materials that respond well to dielectric heating and can be integrated into existing production processes to improve overall efficiency.

The microwave frequency can range from 50 MHz to 50 GHz, with power levels that range from 5 W to 50 MW. Specific frequencies used herein for microwave heating in industrial processes for drying and curing a slurry to form an oral thin film are: 915 MHz and 2450 MHz. Specifically, 915 MHz can be used for larger-scale industrial applications and can provide deeper penetration into materials. 2450 MHz can be widely used for materials processing, including film curing. The choice between these frequencies depends on factors like: the size and thickness of the material being processed, the desired penetration depth, energy efficiency considerations, and equipment availability. For thin films and coatings, 2450 MHz may be preferred due to its widespread availability in industrial microwave equipment and its effectiveness for surface heating. However, for thicker materials or when deeper penetration is needed, 915 MHz may be more suitable.

The effectiveness of microwave heating at these frequencies depends on the dielectric properties of the specific materials being cured or dried. The choice of frequency may be optimized for each particular slurry.

Many semiconductor processing techniques use microwaves to generate plasma for such purposes as reactive ion etching and plasma-enhanced chemical vapor deposition (PECVD).

Microwaves are used in stellarators and tokamak experimental fusion reactors to help break down the gas into a plasma and heat it to very high temperatures. The frequency is tuned to the cyclotron resonance of the electrons in the magnetic field, anywhere between 2-200 GHz, hence it is often referred to as Electron Cyclotron Resonance Heating (ECRH). The upcoming ITER thermonuclear reactor will use up to 20 MW of 170 GHz microwaves.

The term “convection heat” refers to heat obtained by convection. “Convection” refers to the transfer of heat from one place to another by the movement of fluids (e.g., gas, such as air). Convection is usually the dominant form of heat transfer in liquids and gases. Although often discussed as a distinct method of heat transfer, convective heat transfer involves the combined processes of unknown conduction (heat diffusion) and advection (heat transfer by bulk fluid flow). Two types of convective heat transfer can be distinguished: (1) free or natural convection and (2) forced convection. The convection heat employed in the methods of the present invention can include (1) free or natural convection and/or (2) forced convection.

Free or natural convection occurs when fluid motion is caused by buoyancy forces that result from the density variations due to variations of thermal temperature in the fluid. In the absence of an internal source, when the fluid is in contact with a hot surface, its molecules separate and scatter, causing the fluid to be less dense. As a consequence, the fluid is displaced while the cooler fluid gets denser and the fluid sinks. Thus, the hotter volume transfers heat towards the cooler volume of that fluid. Familiar examples are the upward flow of air due to a fire or hot object and the circulation of water in a pot that is heated from below. In contrast, forced convection occurs when a fluid is forced to flow over the surface by an internal source such as fans, by stirring, and pumps, or creating an artificially induced convection current.

The term “wavelength” refers to the spatial period of a periodic wave—the distance over which the wave's shape repeats. It is the distance between consecutive corresponding points of the same phase on the wave, such as two adjacent crests, troughs, or zero crossings, and is a characteristic of both traveling waves and standing waves, as well as other spatial wave patterns. The inverse of the wavelength is called the spatial frequency. Wavelength is commonly designated by the Greek letter lambda (λ). The term wavelength is also sometimes applied to modulated waves, and to the sinusoidal envelopes of modulated waves or waves formed by interference of several sinusoids. Assuming a sinusoidal wave moving at a fixed wave speed, wavelength is inversely proportional to frequency of the wave: waves with higher frequencies have shorter wavelengths, and lower frequencies have longer wavelengths. An example of a wave is light (e.g., UV light) waves.

The term “frequency” refers to the number of occurrences of a repeating event per unit of time. It is also referred to as temporal frequency, which emphasizes the contrast to spatial frequency and angular frequency. Frequency is measured in units of hertz (Hz) which is equal to one occurrence of a repeating event per second. The period is the duration of time of one cycle in a repeating event, so the period is the reciprocal of the frequency.

The term “photon energy” refers to the energy carried by a single photon. The amount of energy is directly proportional to the photon's electromagnetic frequency and thus, equivalently, is inversely proportional to the wavelength. The higher the photon's frequency, the higher its energy. Equivalently, the longer the photon's wavelength, the lower its energy.

Photon energy can be expressed using any unit of energy. Among the units commonly used to denote photon energy are the electronvolt (eV) and the joule (as well as its multiples, such as the microjoule). As one joule equals 6.24×10¹⁸ eV, the larger units may be more useful in denoting the energy of photons with higher frequency and higher energy, such as gamma rays, as opposed to lower energy photons, such as those in the radio frequency region of the electromagnetic spectrum.

The term “black light” or “black light lamp” refers to a device that emits long-wave UVA radiation and little visible light. Fluorescent black light lamps work similarly to other fluorescent lamps, but use a phosphor on the inner tube surface which emits UVA radiation instead of visible light.

“Shortwave UV lamps” are made using a fluorescent lamp tube with no phosphor coating, composed of fused quartz or vycor, since ordinary glass absorbs UVC. These lamps emit ultraviolet light with two peaks in the UVC band at 253.7 nm and 185 nm due to the mercury within the lamp, as well as some visible light. From 85% to 90% of the UV produced by these lamps is at 253.7 nm, whereas only 5-10% is at 185 nm. The fused quartz tube passes the 253.7 nm radiation but blocks the 185 nm wavelength. Such tubes have two or three times the UVC power of a regular fluorescent lamp tube. These low-pressure lamps have a typical efficiency of approximately 30-40%, meaning that for every 100 watts of electricity consumed by the lamp, they will produce approximately 30-40 watts of total UV output.

“Black light incandescent lamps” are also made, from an incandescent light bulb with a filter coating which absorbs most visible light. Halogen lamps with fused quartz envelopes are used as inexpensive UV light sources in the near UV range, from 400 to 300 nm, in some scientific instruments. Due to its black-body spectrum a filament light bulb is a very inefficient ultraviolet source, emitting only a fraction of a percent of its energy as UV.

“Gas-discharge lamps” are a family of artificial light sources that generate light by sending an electric discharge through an ionized gas, a plasma. Typically, such lamps use a noble gas (argon, neon, krypton, and xenon) or a mixture of these gases. Some include additional substances, like mercury, sodium, and metal halides, which are vaporized during startup to become part of the gas mixture. In operation, some of the electrons are forced to leave the atoms of the gas near the anode by the electric field applied between the two electrodes, leaving these atoms positively ionized. The free electrons thus released flow onto the anode, while the cations thus formed are accelerated by the electric field and flow towards the cathode. Typically, after traveling a very short distance, the ions collide with neutral gas atoms, which transfer their electrons to the ions. The atoms, having lost an electron during the collisions, ionize and speed toward the cathode while the ions, having gained an electron during the collisions, return to a lower energy state while releasing energy in the form of photons. Light of a characteristic frequency is thus emitted. In this way, electrons are relayed through the gas from the cathode to the anode. The color of the light produced depends on the emission spectra of the atoms making up the gas, as well as the pressure of the gas, current density, and other variables. Gas discharge lamps can produce a wide range of colors. Some lamps produce ultraviolet radiation which is converted to visible light by a fluorescent coating on the inside of the lamp's glass surface. The fluorescent lamp is perhaps the best known gas-discharge lamp.

“Light-emitting diodes” or “LEDs” can be manufactured to emit radiation in the ultraviolet range. In 2019, following significant advances over the preceding five years, UVA LEDs of 365 nm and longer wavelength were available with efficiencies of 50 percent at 1000 mW output. Such LEDs are increasingly used for UV curing applications, and are already successful in digital print applications and inert UV curing environments. Power densities approaching 3 W/cm² (30 kW/m2) are now possible, and this, coupled with recent developments by photoinitiator and resin formulators, makes the expansion of LED-cured UV materials likely.

An “excimer laser,” sometimes more correctly called an “exciplex laser,” refers to a form of ultraviolet laser. Gas lasers, laser diodes and solid-state lasers can be manufactured to emit ultraviolet rays, and lasers are available which cover the entire UV range. The nitrogen gas laser uses electronic excitation of nitrogen molecules to emit a beam that is mostly UV. The strongest ultraviolet lines are at 337.1 nm and 357.6 nm, wavelength. Another type of high power gas laser is the excimer laser. They are widely used lasers emitting in ultraviolet and vacuum ultraviolet wavelength ranges. Presently, UV argon-fluoride (ArF) excimer lasers operating at 193 nm are routinely used in integrated circuit production by photolithography. The current wavelength limit of production of coherent UV is about 126 nm, characteristic of the Ar2* excimer laser. Direct UV-emitting laser diodes are available at 375 nm. UV diode-pumped solid state lasers have been demonstrated using Ce:LiSAF crystals (cerium-doped lithium strontium aluminum fluoride). Wavelengths shorter than 325 nm are commercially generated in diode-pumped solid-state lasers. Ultraviolet lasers can also be made by applying frequency conversion to lower-frequency lasers.

The term “reflector” refers to a device that causes reflection (for example, a mirror or a retroreflector). The reflector can be an improvised or specialized reflective surface used to redirect light towards a given object.

The term “surrounding air temperature” refers to the air temperature in the area around a substance. The substance can be the substrate having the slurry located thereon, to be cured. The area around the substance will typically be the space within 10 feet of the substance. Within the context of curing a cast slurry as described herein, the surrounding air temperature may vary among the specific curing (or heating) zones. Specifically, each zone (e.g., heating or curing zone) can have the same, or different, surrounding air temperature. Within any such zone, the surrounding air temperature will typically be, e.g., less than 135° F., less than 120° F., or less than 110° F. For example, each zone can have a different surrounding air temperature, such that the surrounding air temperature in each zone is higher than the surrounding air temperature in any immediately subsequent zone. Alternatively, each zone can have a different surrounding air temperature, such that the surrounding air temperature in each zone is lower than the surrounding air temperature in any immediately subsequent zone. Alternatively, each zone can have a different surrounding air temperature, such that the surrounding air temperature in each zone is independently higher or lower than the surrounding air temperature in any immediately subsequent zone.

Specifically, forming a cured film employing the method described herein includes curing a cast slurry with UVR (alone or in combination with convection heat). The cast slurry will typically be located on a substrate and the substrate will typically move (in the machine direction) along the one or more heating (or curing) zones. Within any heating zone(s), a heat source will provide an amount of heat to aid in the curing. While the heat source will be located a suitable distance from the substrate, the substrate will none-the-less be heated. The amount of heat emitted from the heat source can be measured, as can the temperature of the air surrounding the substrate. Given that the temperature of the slurry may not be readily, effectively, and accurately measured, reference to the temperature of the air surrounding the substrate can be made. Additionally, within any curing zone(s) with no heating (e.g., no heat source), the temperature of the air surrounding the substrate will approximately be the ambient temperature (e.g., the temperature in the room, which will presumably be 65-75° F.).

The term “zone” refers to an area or a region distinguished from adjacent parts by a distinctive feature or characteristic. The zone can be any continuous area that differs in some respect, or is distinguished for some purpose, from adjoining areas, or within which certain distinctive circumstances exist or are established. The zone can have any suitable size. For example, along the machine direction, the length of each heating (or curing) zone can be up to 15 feet. Additionally, there can be any suitable number of zones present. For example, there can be up to 5 (e.g., 1, 2, 3, 4, or 5) heating (or curing) zones present.

The term “rate” refers to the rate of speed. Within the context of curing a cast slurry as described herein, the rate of the substrate will typically refer to the rate of speed (in the machine direction), of the substrate (wherein the substrate is configured for a slurry to be located thereon, and in specific embodiments the substrate contains the slurry located thereon). The rate will typically controlled, e.g., 0.1 feet per minute to 10 feet per minute.

The term “air velocity” refers to the velocity of forced air. Within the context of curing a cast slurry as described herein, the air velocity will typically refer to velocity of forced air over the substrate (wherein the substrate is configured for a slurry to be located thereon, and in specific embodiments the substrate contains the slurry located thereon). The air velocity will typically be controlled, e.g., at 3500-7000 feet per minute.

The term “photoinitiator” refers to is a substance that creates reactive species (e.g., free radicals, cations, or anions) when exposed to UV radiation. Photoinitiators include synthetic and natural compounds. Photoinitiators are typically key components in some photopolymers.

The term “photopolymer,” “light-activated polymer” or “photo-curable polymer” refers to a polymer that changes its properties when exposed to UV light. These changes are often manifested structurally, for example hardening or curing as a result of cross-linking of the polymer when exposed to UV light. The photopolymer can be a polymer having one or more attached photoreactive groups, wherein each photoreactive group is pendent from the polymeric portion of a hydrophilic polymer. The photopolymer can be cured alone, or by employing a photoactivatable cross-linking agent. The polymeric portion of the photopolymer can be either a homopolymer or a copolymer, and typically is hydrophilic and/or biocompatible. The photopolymer can be formed using any sort of synthetic process that will result in the formation of a hydrophilic polymer with one or more pendent photoreactive groups. The photoreactive groups can be present at the terminal portions (ends) of the polymeric strand or can be present along the length of the polymer, or combinations thereof. Specifically, the photoreactive groups can be located randomly along the length of the polymer. The photopolymer can be synthesized by attaching photoreactive groups to a hydrophilic polymer. The polymer can be obtained from a commercial source or be synthesized from the polymerization of a desired monomer or combination of different monomers. In specific embodiments, the photopolymer can be a film forming polymer. Three types of UV lamps suitable for UV polymer curing include High Pressure UV (HPUV) (also referred to as Metal Halide lamps), Medium Pressure UV (MPUV), and Amalgam Lamps.

The term “UV stable” or “photostable” refers to a substance (e.g., active ingredient) being resistant to change under the influence of UV radiation. The photostable substance will remain unchanged (e.g., resist degradation) upon exposure to UV radiation. For example, upon 10 minutes of exposure to UV radiation having a wavelength of 400-280 nm and photon energy of 3.10-4.43 eV, less than 1 wt. % of the substance will change.

The term “heat sensitive” refers to a substance (e.g., active ingredient) that will change under the influence of elevated temperature (e.g., above 150° F.). The heat sensitive substance will change (e.g., degrade) upon exposure to an elevated temperature. For example, upon 60 minutes of exposure at 150° F. and a relative humidity (RH) of 65%, at least 5 wt. % of the substance will change.

### Specific Ranges, Values, and Embodiments

The specific embodiments describing the ranges and values provided below are for illustration purposes only, and do not otherwise limit the scope of the disclosed subject matter, as defined by the claims.

### Process Details and Variations

### Microwave Power Levels and Delivery

In specific embodiments, the microwave radiation is applied at a power level ranging from 0.05 W/cm² to 20 W/cm².

In specific embodiments, the microwave radiation is applied at a power level ranging from 0.1 W/cm² to 20 W/cm².

In specific embodiments, the microwave radiation is applied at a power level ranging from 0.05 W/cm² to 10 W/cm².

In specific embodiments, the microwave radiation is applied at a power level ranging from 0.1 W/cm² to 10 W/cm².

In specific embodiments, the total microwave power ranges from 50 W to 50 kW.

In specific embodiments, the total microwave power ranges from 10 W to 50 kW.

In specific embodiments, the microwave radiation is delivered in a pulsed mode, continuous wave mode, or via a power ramping profile across the cure cycle.

In specific embodiments, the microwave radiation is delivered in a pulsed mode, continuous mode, or modulated according to a time-dependent power profile.

In specific embodiments, the microwave radiation is delivered in pulsed, continuous, or modulated (time-dependent) power profiles.

In specific embodiments, the microwave curing is performed at a frequency selected from 915 MHz, 2450 MHz, or another frequency between 300 MHz and 3 GHZ, based on the dielectric properties of the slurry and film materials.

In specific embodiments, the UV radiation has a wavelength between 200 nm and 400 nm, and is delivered using UVA, UVB, or UVC lamps, LEDs, or excimer lasers.

In specific embodiments, the microwave frequency is selected from 300 MHz to 3 GHZ, and, in narrower embodiments, specifically 915 MHz or 2450 MHz.

In specific embodiments, the UV radiation has a wavelength of 180 nm to 420 nm, and, in narrower embodiments, comprises UVA, UVB, or UVC sources, such as LEDs, mercury lamps, or excimer lasers.

### Temperature and Environmental Control

In specific embodiments, the curing is performed under controlled humidity conditions, wherein the relative humidity is maintained below 40%.

In specific embodiments, the curing occurs in an inert atmosphere, such as under nitrogen purge, to minimize oxidation or undesired chemical reactions.

In specific embodiments, each curing zone is equipped with feedback control for air temperature regulation to ensure uniform curing.

In specific embodiments, the curing atmosphere is an inert gas (e.g., nitrogen, argon) to reduce oxidation, or comprises controlled humidity below 40%.

In specific embodiments, the curing occurs across a thermal gradient, with air temperature ranging from ambient (20° C.) to 80° C., or with a decreasing or increasing gradient over multiple zones.

In specific embodiments, the curing is performed in two or more zones, wherein microwave frequency, power, and air temperature differ in each zone.

In specific embodiments, the curing chamber comprises feedback sensors to regulate temperature, microwave power, and humidity in real-time.

In specific embodiments, the process includes an initial pre-curing stage using lower energy input, followed by a main curing stage.

In specific embodiments, the process integrates convection heating, microwave radiation, and UV radiation in sequence or simultaneously.

In specific embodiments, the curing step is performed in an atmosphere of air, nitrogen, argon, or in a vacuum, and/or under a humidity controlled to below 40% RH.

In specific embodiments, the curing step utilizes a temperature gradient, with air temperature starting at 20° C.-80° C. and varied over one or more curing zones.

### Curing Profiles and Multi-Stage Processes

In specific embodiments, the cast slurry is cured via a stepwise process comprising sequential exposure to increasing or decreasing microwave frequencies, or alternating between UV and microwave treatment.

In specific embodiments, the cast slurry undergoes a pre-curing step utilizing low energy microwave or UV exposure, followed by a primary curing step.

In specific embodiments, the cast slurry is moved through at least two zones, each zone differing in at least one of: microwave frequency, microwave power, air temperature, or air velocity.

In specific embodiments, feedback sensors regulate microwave power, air temperature, and humidity, adjusting parameters in real-time to optimize film properties.

In specific embodiments, the process includes a pre-curing stage with lower energy input, followed by a primary curing stage at higher energy or a finishing stage of convection or UV curing.

In specific embodiments, the process further comprises a drying or conditioning step after curing, such as air-drying, oven-drying, or placement in a humidity-controlled chamber.

In specific embodiments, the finished film is further subdivided or packaged under inert gas or vacuum to enhance stability.

### Substrate Variations

In specific embodiments, the slurry is cast onto a substrate comprising polytetrafluoroethylene (PTFE), silicone, or coated metals.

In specific embodiments, the substrate material is selected to optimize release of the finished film and improve process efficiency.

Integration with Downstream Processes

In specific embodiments, the manufacturing process integrates film cutting, scoring, and packaging in-line with curing.

In specific embodiments, the process incorporates in-line quality control systems, such as in situ spectroscopy or imaging for thickness and drug load uniformity.

### Film Composition and Functional Components

### Film Compositions

In specific embodiments, the cast slurry includes active ingredient(s) and one or more excipients, each of which is independently synthetic or natural.

In specific embodiments, the cast slurry includes one or more excipients, each of which is independently medical or food grade.

In specific embodiments, the cast slurry includes a film-forming polymer, API, solvent, plasticizer, and a crosslinking agent selected from photo-initiators, thermal initiators, or chemical crosslinkers.

In specific embodiments, the polymer matrix comprises one or more polymers selected from HPMC, PVA, pullulan, alginate, gelatin, and chitosan.

In specific embodiments, the oral dissolvable film contains at least two distinct polymeric matrices, each formulated for different dissolution rates or API release profiles.

In specific embodiments, the API is incorporated in the form of nanoparticle, microparticle, or microencapsulated forms for enhanced stability or targeted release.

In specific embodiments, the composition includes permeability enhancers, such as bile salts, surfactants, fatty acids, or fatty alcohols.

In specific embodiments, the film includes excipients for API protection during curing, including antioxidants, UV stabilizers, or heat stabilizers.

In specific embodiments, the film contains a mucoadhesive polymer selected from carbopol, chitosan, or thiolated polymers to increase residence time on the mucosa.

In specific embodiments, a flavoring agent is selected from botanical extracts with anti-inflammatory or functional medicinal activity, such as ginger or curcumin.

In specific embodiments, the composition includes an antimicrobial preservative (e.g., sodium benzoate, potassium sorbate, or parabens) at levels sufficient to meet USP <51> guidelines.

In specific embodiments, the oral dissolvable film is coated with a powder matrix applied by atomization, screening, or admixing with a volatile carrier.

In specific embodiments, the cast slurry includes: a film-forming polymer, API, solvent, plasticizer, and one or more crosslinking agents selected from photo-initiators, thermal initiators, or chemical crosslinkers.

In specific embodiments, the film-forming polymer comprises one or more of hydroxypropyl methylcellulose (HPMC), polyvinyl alcohol (PVA), pullulan, sodium alginate, gelatin, or chitosan.

In specific embodiments, the oral dissolvable film comprises two or more polymeric matrices for controlled, biphasic, or pulsatile release.

In specific embodiments, the API is in the form of a nanoparticle, microparticle, liposomal, or microencapsulated composition.

In specific embodiments, the film includes a permeability enhancer selected from bile salts, surfactants, fatty acids, or fatty alcohols.

In specific embodiments, the film composition further comprises antioxidants, UV-stabilizers, or heat stabilizers, such as ascorbic acid, sodium metabisulfite, or titanium dioxide, to protect the API during curing.

In specific embodiments, a mucoadhesive polymer selected from carbopol, chitosan, or thiolated polymers is included at 0.1-10% w/w, optionally to increase residence time on the mucosa.

In specific embodiments, a flavoring agent is included, selected from botanical extracts with functional or medicinal activity, such as ginger extract or curcumin.

In specific embodiments, the film comprises an antimicrobial preservative selected from sodium benzoate, potassium sorbate, or parabens, alone or in combination, in an amount sufficient to meet USP <51> criteria.

In specific embodiments, the finished film has an external powder or particulate coating applied by atomization, sifting, or with a volatile carrier, optionally containing additional taste masking, mucoadhesive, or active agents.

### Polymer or Matrix Crosslinking Agents

In specific embodiments, the slurry includes a photoreactive crosslinking agent selected from photo-initiators or thermal initiators.

In specific embodiments, the oral dissolvable film comprises multiple layers or matrices, each possessing distinct dissolution rates or compositions.

### API Protection Strategies

In specific embodiments, the film composition includes heat-stabilizing or UV-stabilizing excipients, such as antioxidants or UV absorbers, to improve API stability during curing.

In specific embodiments, the API is formulated as microencapsulated particles or nanoparticles dispersed within the polymeric film matrix.

### Novel Excipients or Additives

In specific embodiments, the excipient composition includes a permeability enhancer selected from bile salts, surfactants, or fatty acids.

In specific embodiments, the film includes a mucoadhesive polymer with thiolated functional groups for enhanced mucosal retention.

In specific embodiments, the oral dissolvable film contains a bioactive flavoring agent, such as a natural anti-inflammatory compound derived from ginger or turmeric.

In specific embodiments, an anti-microbial preservative is included in an amount sufficient to meet USP <51> antimicrobial effectiveness requirements.

### Device or Apparatus Claims

### Specialized Curing Equipment

In specific embodiments, the oral dissolvable film is manufactured in an apparatus comprising a multi-zone microwave tunnel or hybrid oven having modular UV and microwave lamps.

In specific embodiments, the curing apparatus includes an automated conveyor system for continuous or semi-continuous manufacturing.

In specific embodiments, optional embedded sensors, including thermocouples, infrared sensors, and moisture analyzers, are used to monitor film temperature and water content during processing.

In specific embodiments, the curing device comprises a multi-zone microwave tunnel, each with independent power and temperature control.

In specific embodiments, the curing apparatus includes integrated modular units for UV curing and microwave curing, which can operate sequentially or simultaneously.

In specific embodiments, the film manufacturing line includes an automated conveyor and scoring, cutting, or packaging stations inline with curing.

In specific embodiments, the device incorporates sensors for real-time measurement of water content, temperature, film thickness, API uniformity, and visual inspection.

In specific embodiments, the manufacturing apparatus utilizes closed-loop feedback mechanisms for quality assurance, such as spectroscopic or imaging-based API distribution analysis.

In specific embodiments, rejected films are automatically removed from the line based on in-process sensor feedback.

In specific embodiments, the device for curing comprises a multi-zone microwave tunnel, each zone having independent and programmable frequency, power, and temperature settings.

### Method of Use and Quality Assurance Claims

### In-Process Monitoring and Control

In specific embodiments, the manufacturing process is conducted in batch, semi-continuous, or continuous fashion.

In specific embodiments, the process includes a sterilization step for the substrate, equipment, or finished film, such as UV irradiation, ethanol rinsing, or autoclave.

In specific embodiments, film temperature, solvent evaporation rate, and total energy input are continuously or intermittently monitored and controlled.

In specific embodiments, the manufacturing process includes feedback mechanisms that monitor and control drug content uniformity, film thickness, disintegration time, and API content in real time.

In specific embodiments, commercial thickness ranges are measured by micrometer, optical, or in-line sensors.

In specific embodiments, the process incorporates automated rejection of non-conforming film units based on in-process measurements.

In specific embodiments, the curing apparatus is modular, combining independently controlled units for microwave curing and UV curing, which may operate sequentially or simultaneously.

In specific embodiments, the film manufacturing line combines, in sequence or in parallel, automated film casting, cutting/scoring, packaging, and in-line curing.

In specific embodiments, real-time sensor arrays are incorporated to monitor at least one of: film thickness, moisture content, temperature, API content, and uniformity by spectroscopic or imaging techniques.

In specific embodiments, rejected films or defective portions are automatically identified and removed from the process line by feedback from in-process sensors.

In specific embodiments, the manufacturing apparatus includes closed-loop control for process parameters, based on predefined film quality metrics or operator input.

1. A method of manufacturing an oral dissolvable film, the method comprising:
(a) forming or obtaining a cast slurry; and
(b) curing the cast slurry with microwave radiation, alone or in combination with convection heat, to provide a cured oral dissolvable film.

2. The method of claim 1, wherein the microwave radiation has a frequency of 915 MHz or 2450 MHz.

3. The method of claim 1, wherein the microwave radiation has a frequency of 915 MHz.

4. The method of claim 1, wherein the microwave radiation has a frequency of 2450 MHz.

5. The method of claim 1, wherein a magnetron is employed as the energy source of the microwave radiation.

6. The method of claim 1, wherein the curing is carried out at a surrounding air temperature of less than 140° F.

7. The method of claim 1, wherein the curing is carried out over multiple zones, each having a different surrounding air temperature, different microwave radiation frequency, different microwave radiation power, or combination thereof.

8. The method of claim 1, wherein the curing is carried out over multiple zones, each having a length of up to 12 feet.

9. The method of claim 1, wherein the curing is carried out at over 2-5 zones, each having a different surrounding air temperature, different microwave radiation frequency, different microwave radiation power, or combination thereof.

10. The method of claim 1, wherein the curing is carried out at over two zones, each having a different surrounding air temperature, different microwave radiation frequency, different microwave radiation power, or combination thereof.

11. The method of claim 1, wherein the curing is carried out at over three zones, wherein:
the surrounding air temperature in the first zone is different from the surrounding air temperature in the second zone; and
the surrounding air temperature in the second zone is different from the surrounding air temperature in the third zone.

12. The method of claim 1, wherein the curing is carried out at over three zones, wherein:
the surrounding air temperature in the first zone is higher than the surrounding air temperature in the second zone; and
the surrounding air temperature in the second zone is higher than the surrounding air temperature in the third zone.

13. The method of claim 1, wherein the curing is carried out at over three zones, wherein:
the surrounding air temperature in the first zone is less than 135° F.;
the surrounding air temperature in the second zone is less than 120° F.; and
the surrounding air temperature in the third zone is less than 110° F.

14. The method of claim 1, wherein the curing is carried out at a rate of 0.8 feet per minute to 4 feet per minute.

15. The method of claim 1, wherein the cast slurry comprises:
(a) film forming agent;
(b) active pharmaceutical ingredient (API);
(c) solvent; and
(d) pharmaceutically acceptable excipient comprising at least one of a mucoadhesive polymer, plasticizer, binder, filler, bulking agent, saliva stimulating agent, stabilizing and thickening agent, gelling agent, flavoring agent, taste masking agent, coloring agent, pigment, lubricant, release modifier, adjuvant, sweetening agent, solubilizer & emulsifier, fragrance, emulsifier, surfactant, pH adjusting agent, buffering agent, lipid, glidant, stabilizer, antioxidant, anti-tacking agent, humectant, solvent, and preservative.

16. The method of claim 1, further comprising after (a) forming or obtaining a cast slurry; and (b) curing the cast slurry with microwave radiation, alone or in combination with convection heat, to form a cured film:
(c) converting the cured film into desired dimensions to provide a cured film in a unit dosage form; and
(d) packaging.

17. The method of claim 1, wherein the cast slurry in (a) is formed by extruding a slurry and casting onto a substrate.

18. The method of claim 1, wherein the cured film is in the form of a self-supporting continuously cast film.

19. The method of claim 1, wherein upon placing in the oral cavity, the oral dissolvable film disintegrates within 90 seconds.

20. The method of claim 1, wherein the oral dissolvable film is formulated for delivery of the API sublingually, mucosally, enterally, buccally, or any combination thereof.

21. The method of claim 1, wherein the oral dissolvable film has a thickness of 0.2-0.7 mm.

22. The method of claim 1, wherein the oral dissolvable film has a mass of 180-260 mg.

23. The method of claim 1, wherein the oral dissolvable film has a drug load of API of 28-38 wt. %.

24. The method of claim 1, wherein the oral dissolvable film has a density of 0.60-0.85 g/cm³.
